(19) United States
(12) Patent Application Publication
(10) Pub. No.: US 2026/0288920 A1
(43) Pub. Date: Sep. 24, 2026

(54) USER VERIFICATION VIA SECURE FEDERATED MACHINE LEARNING

(71) Applicant: QUALCOMM Incorporated, San Diego, CA (US)

(72) Inventors: Matthias REISSER, Palo Alto, CA (US); Christos LOUIZOS, Amsterdam (NL); Joseph Binamira SORIAGA, San Diego, CA (US); Evgeni GOUSEV, Saratoga, CA (US)

(21) Appl. No.: 18/881,161

(22) PCT Filed: Jun. 16, 2023
(86) PCT No.: PCT/US2023/068565

§ 371 Date: Jan. 3, 2025

(30) Foreign Application Priority Data
Sep. 7, 2022 (GR) 20220100730

(51) Int. Cl. G06F 21/32; G06N 3/098; G06N 20/00

(52) U.S. Cl. CPC G06F 21/32; G06N 3/098; G06N 20/00

(57) ABSTRACT

Certain aspects of the present disclosure provide techniques and apparatus for improved machine learning. A user verification (UV) machine learning model trained on at least one other computing device is accessed by a first computing device. A first identifying signal corresponding to a first user is received, and a first embedding is generated by processing the first identifying signal using the UV machine learning model. A score is generated based on the first embedding and a first stored embedding, and an output is generated based on the score.

### CROSS-REFERENCE TO RELATED APPLICATIONS

This application claims priority to Greek Patent Application No. 20220100730, filed Sep. 7, 2022, the entire contents of which are incorporated herein by reference.

### INTRODUCTION

Aspects of the present disclosure relate to machine learning.

Machine learning architectures have been used to provide solutions for a wide variety of computational problems. Training machine learning models to perform accurately and reliably typically uses vast amounts of data (as well as significant computational resources) which are often not available in common deployment systems (e.g., on an end-user's smartphone). Moreover, in many solutions, some level of user-customization (e.g., training the model using data specific to the end user, such that each user has a corresponding personalized model) is desirable for improved model performance. However, such customization relies on personalized data for each user, and conventional approaches generally involve the user providing substantial manual effort, as well as bearing significant computational expense, to enable the model customization. Conventional efforts to reduce this burden, such as via federated learning, either cannot be used for common user verification problems (which generally rely on negative examples, or data from other users, to adequately train the model) and/or introduce substantial privacy and security concerns (e.g., if such private data is transmitted to the central server for adequate training).

### BRIEF SUMMARY

Certain aspects provide a method comprising: accessing, by a first computing device, a user verification (UV) machine learning model trained on at least one other computing device; receiving a first identifying signal corresponding to a first user; generating a first embedding by processing the first identifying signal using the UV machine learning model; generating a score based on the first embedding and a first stored embedding; and generating an output based on the score.

Certain aspects provide a method, comprising: receiving, at a central server, a plurality of updates from a plurality of untrusted computing devices using a federated learning operation, the plurality of updates generated based on identifying data for a plurality of users; generating, by the central server, a user verification (UV) machine learning model based on the plurality of updates; and deploying the UV machine learning model to an access-controlled computing device, wherein: the access-controlled computing device did not participate in the federated learning operation and is not controlled by any of the plurality of users, and the access-controlled computing device uses the UV machine learning model to verify identities of at least one of the plurality of users.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts an example workflow for private and secure training and deployment of machine learning models.

FIG. 2 depicts an example workflow for private and secure inferencing using machine learning models.

FIG. 3 depicts an example workflow for generating authorized embeddings to enable private and secure machine learning.

FIG. 4 is a flow diagram depicting an example method for private and secure training and deployment of machine learning models.

FIG. 5 is a flow diagram depicting an example method for private and secure inferencing using machine learning models.

FIG. 6 is a flow diagram depicting an example method for securely using machine learning models.

FIG. 7 is a flow diagram depicting an example method for securely training machine learning models.

FIG. 8 depicts an example processing system configured to perform various aspects of the present disclosure.

FIG. 9 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for improved machine learning model customization and use with enhanced privacy and security. In some aspects, techniques for multi-user and multi-device access are provided using federated learning approaches that preserve user privacy and data security.

Machine learning models have been increasingly used for user verification (UV) in various settings. For example, UV models may be used to selectively grant access (e.g., to unlock a smartphone) based on the user's face, fingerprint, voice, and the like. Generally, UV involves granting access (or generating some other output) to specific authorized user(s), while denying access (and, in some aspects, triggering alarms or other output) to non-authorized users (which may be unregistered users, or may be users that are explicitly unauthorized). UV models can evaluate a variety of user-specific characteristics or modalities, such as fingerprints, voice commands, visual appearance (e.g., face, gestures, walking gait), and the like, depending on the particular implementation. In some aspects, these input characteristics may be referred to as biometric data. As used herein, the phrase “identifying signal” means any user-specific characteristic or attribute (e.g., biometric data) that can be evaluated using UV models to selectively grant access or otherwise recognize authorized users.

Training machine learning models, including UV models, typically involves use of substantial training data that is not generally available to individual end users. For example, any given user is unlikely to have the thousands of exemplars (or more), such as images of the user's face, that are often used for ordinary training. In some conventional approaches, this private data (e.g., images of the users' faces) is collected by a central system, and used to train such models. In some approaches, to help remediate privacy concerns, a central model can be trained using data from a large number of users, and this model can be fine-tuned locally, by each user, using data for the specific user. This may be referred to as enrollment, in some aspects. However, in conventional systems, the access-secured device also engages in the training or refinement for this model enrollment approach, and the model is subsequently deployed on the device that performed the enrollment. For example, to use a UV model to unlock a smartphone, the smartphone itself typically performs the enrollment and refinement process. This significantly limits the applicability and use of such models.

Federated learning (FL) generally involves jointly training a model across multiple participating clients or systems. In some aspects, each participating device performs model training locally using a set of local training data (e.g., identifying signals for the user of the participating device) and transmits model updates to a central host that aggregates the model updates from multiple participants to generate a global model. This global model can then be redistributed to the participating devices for a new round of training. In such aspects, the training may occur only on each user's trusted device, such as their smartphone, which allows their private data (e.g., identifying signals) to be retained (e.g., not transmitted to or otherwise available on the central server).

However, FL generally cannot be used for accurate UV model training in conventional systems. Specifically, each participating device may have access only to a single user's data (or a small group of users' data, such as amongst a mutually trusted group of users), which demands that the FL handle a variety of non-independent and identically distributed (IID) characteristics of the distributed dataset (whereas conventional FL generally relies on or at least benefits from the data being IID). Generally, non-IID problems are particularly difficult for FL to solve. In some aspects of the present disclosure, each local model may be trained using only positive exemplars and positive loss terms (e.g., true images of the user), while conventional UV models also rely on negative exemplars and loss terms (e.g., images of other users) in order to ensure that the resulting model distinguishes accurately between users.

In aspects of the present disclosure, techniques are provided to enable FL systems to train UV models in a way that preserves user privacy and security (e.g., where identifying signals of each user are unavailable at the central server or on any other participating client devices) while ensuring high model accuracy. These models can then be distributed to a variety of access-controlled systems for inferencing. Notably, using aspects of the present disclosure, these access-controlled systems need not be trusted devices of any of the participating users, and need not participate in the training or refinement process itself. In this way, users may use their private data to assist in training or refining a UV machine learning model at one time, and this model may be deployed for use across multiple devices and settings, enabling use of accurate UV machine learning in a more expansive and flexible way (e.g., as opposed to conventional approaches where the user re-enrolls or re-trains the model for each access-controlled device, and where the user generally has control or ownership of the access-controlled devices).

In some aspects, each user can enroll or participate in the training process once using a trusted device, such as a smartphone (e.g., the user need not enroll or train the model separately for each access device), and the model can be deployed to a variety of access-controlled devices such as smart door locks (e.g., for short-term rentals, commercial building access, and the like). To enable access to the space, in some aspects, the user can be registered with the specific access-controlled devices, as discussed below in more detail, without sharing identifying information. This allows the set of authorized users to be updated rapidly and efficiently without exposing user privacy and security, and without requiring the user to participate in a renewed training round.

### Example Workflow for Private and Secure Training and Deployment of Machine Learning Models

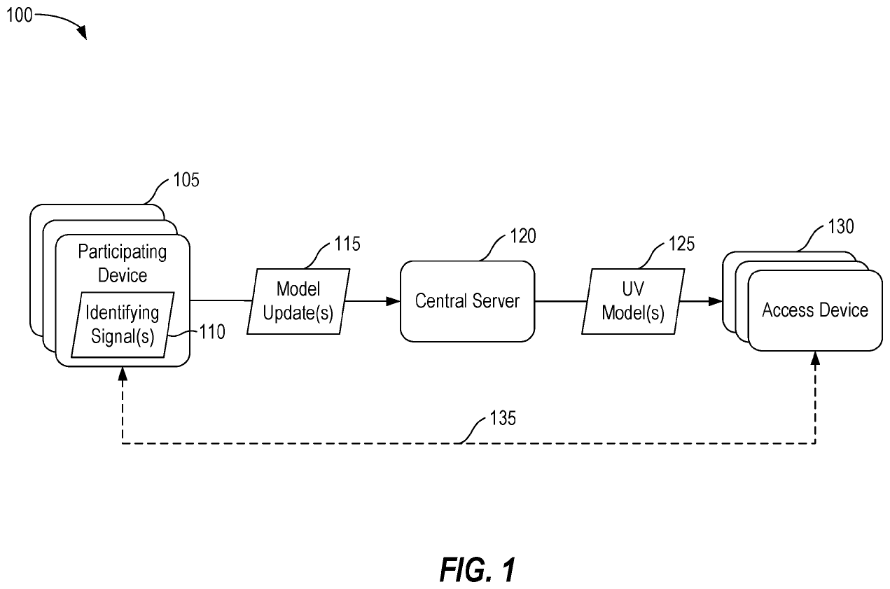

FIG. 1 depicts an example workflow 100 for private and secure training and deployment of machine learning models.

In the illustrated example, a set of participating devices 105 engage in a federated learning process with a central server 120 to jointly train one or more UV models 125. Although a set of discrete participating devices 105 are depicted for conceptual clarity, in some aspects, one or more of the participating devices 105 may be implemented using hardware, software, or a combination of hardware and software, and may be implemented as part of one or more broader systems. Generally, the participating devices 105 correspond to trusted devices or systems of users that wish to enroll in the UV system.

As used herein, a device or system may be referred to as “trusted” with respect to a user or client to indicate that the system stores, processes, evaluates, uses, or otherwise maintains private or secure information of the user (e.g., identifying and/or biometric data). In contrast, a device or system may be referred to as “untrusted” or “unverified” to indicate the lack of such trust. That is, the term “untrusted” need not mean that the device is untrustworthy or unsafe with respect to any given user. Instead, a device may be referred to as “untrusted” to indicate that the device has not been verified or evaluated by the user, is not controlled or owned by the user, or otherwise may or may not be a trustworthy device. For example, an “untrusted” device may be one that is not trusted to receive, process, or store such identifying/biometric data for the user.

For example, in the illustrated example, each participating device 105 is a trusted device of at least one respective user, and each participating device 105 uses a corresponding set of identifying signals 110 (e.g., fingerprints, images of the user's face, and the like) to participate in the training process. However, as illustrated, these identifying signals 110 are generally not available at the central server 120, access device(s) 130, or any other participating device 105. That is, the central server 120 and access device(s) 130 may be referred to as “untrusted” with respect to any given user. Further, as each participating device 105 may use the corresponding set of identifying signal(s) 110 without accessing or receiving the identifying signals 110 from any other user or device, each participating device 105 may be referred to as “untrusted” with respect to other users, even while the participating device 105 is “trusted” with respect to the user that owns or uses the participating device 105 to participate in the training process. Generally, each participating device 105 can refrain from transmitting the identifying signals 110 to any other system or device in the workflow 100.

In some aspects, each user (also referred to as a client) may be associated with a single participating device 105. That is, each user can use a single participating device 105 to participate in the FL system. Thereafter, the user may use the UV model(s) 125, as discussed in more detail below, for verification or authentication by a variety of access devices 130. The participating devices 105 may generally include a wide variety of computing devices, such as (but not limited to) smartphones, laptop computers, desktop computers, tablets, head-mounted displays (HMDs), smart watches, and the like.

In some aspects, to jointly train the UV models 125, each respective participating device 105 uses its respective identifying signal(s) 110 to refine one or more parameters of the model locally. Generally, the UV model 125 (and each local model being trained by each participating device 105) comprises a machine learning model (e.g., a neural network) that generates output embeddings based on input identifying signals 110. These embeddings can then be compared against a defined set of authorized embeddings for authorized users. If the distance or difference between the generated embedding is within a defined or variable distance from an authorized embedding, then the FL system can determine that the input identifying signal is from an authorized user.

In some aspects, therefore, to train the UV model 125 to generate reliable embeddings, the participating devices 105 may each process one or more identifying signals 110 using a local copy of the model in order to generate an embedding. This embedding can then be compared against a ground-truth embedding for the user, and the local model can be refined based on the difference. In this way, the local model(s) each learn to generate more accurate embeddings for their specific user.

In some aspects, to enhance or preserve privacy and security and prevent the sharing of identifying signals 110 between devices while still enabling federated training of the UV model, the participating devices 105 can each train a local model using a hidden or obfuscated identifier as the target output. For example, as discussed below in more detail, in some aspects, the target embedding may be generated using a unique user identifier (e.g., assigned by the central server 120 or other entity), a random tensor or value (e.g., selected by the participating device 105), and one or more parity bits, which may cause the embeddings from different users (generated using different unique identifiers and random values) to be dissimilar (and in some cases, maximally dissimilar), thereby increasing the minimum distance between clusters in the embedding space and facilitating training of the UV model without the use of negative exemplars during training.

In some aspects, as discussed below in more detail, each participating device 105 can further combine or aggregate this personal identifier with a set of learned parameters (e.g., multiplying the personal identifier by a weight matrix with values learned during the training process) in order to further obfuscate the personal identifier. The generated embeddings (created by the machine learning model processing input data) can then be compared to this obfuscated identifier embedding, thereby enabling the models to learn to generate embeddings, based on the identifying signals 110, which approximate or approach target embeddings (which, as discussed in more detail below, may be generated by combining data such as assigned user identifiers, selected random values, parity bits, and learned values).

In some aspects, each participating device 105 can use any number of identifying signals 110 to perform the local training of the model, in accordance with the FL system. As illustrated, for each round of the FL process, each participating device 105 transmits a corresponding set of model updates 115 to the central server 120. In some aspects, the model updates 115 can generally include updated model parameters and/or parameter gradients. For example, if the UV model 125 is a neural network, then the model updates 115 may include, from each participating device 105, a set of updated weights (generated based on respective identifying signals 110), a set of weight gradients, and the like. In some aspects, as discussed below in more detail, the model updates 115 further include updated values or gradients for the weight tensor used to generate the target embeddings.

As illustrated, the central server 120 may then use the model updates 115 from each (or at least some) of the participating device 105 to generate an aggregate or global UV model 125. For example, the central server 120 may sum the updates, average the updates, find the median of the updates, generate a weighted average of the updates, and the like.

Although a single round of training is depicted (where the central server 120 aggregates a single set of model updates 115 to generate the UV model 125), in aspects, there may be multiple such rounds. That is, the central server 120 may aggregate the updates to generate an updated global UV model 125, and the central server 120 may transmit this updated global model 125 to each participating device 105. Each participating device 105 may then use the respective identifying signal(s) 110 to refine the updated global model (thereby creating a new updated local model), transmit new model updates 115 to the central server 120 for aggregation, and so on until training is complete.

Although the illustrated example suggests that all participating devices 105 participate in all rounds of the FL operation, in some aspects, a subset of the devices may be used in any given round. For example, the central server 120 may select a subset of the participating devices (e.g., ten percent) using any suitable technique (including randomly or pseudo-randomly) to participate in each round.

As discussed above, using aspects of the present disclosure, the central server 120 need not receive or access the identifying signals 110 of the users. Nevertheless, the UV model 125 learns to generate embeddings, based on input identifying signals, which can reliably be used to authenticate or verify whether the corresponding user (associated with the identifying signal) is included in a set of authorized users. As used herein, “accessing” data may generally include reading, receiving, retrieving, storing, extracting, obtaining, processing, modifying, or otherwise interacting with or gaining access to the data. In some aspects, though the central server 120 does not receive or access the identifying signals 110 themselves, the central server 120 does receive the results of computation on that data (e.g., the model updates 115), which may be used to infer or reconstruct some or all of the identifying signals 110. In some aspects, therefore, various security-enhancing techniques may be used, such as differential privacy, secure aggregation, and the like, which can be used to further protect the client's private data.

In the illustrated workflow 100, once the training process completes, the central server 120 can then deploy or transmit the trained UV model 125 to one or more access devices 130. As discussed above, each access device 130 may be untrusted with respect to one or more users. For example, the access devices 130 may include shared systems such as security systems or smart locks in a commercial or residential space (e.g., an office space, a short-term house or hotel rental, a private section of a park, and the like).

In the illustrated workflow 100, the access devices 130 need not engage in the training process (e.g., the access devices 130 do not use identifying signals 110 to generate model updates 115). However, in some aspects, one or more of the access devices 130 may also serve as trusted participating devices 105 for one or more users. That is, while some access devices 130 (e.g., smart locks in an office space) may receive the UV model(s) 125 without participating in the training or being owned or controlled by any participating users, other access devices 130 (e.g., smartphones having biometric unlock capability) may both participate in the training process, as well as receive the final UV model 125 for inferencing.

As illustrated by arrow 135, one or more of the participating devices 105 may register or otherwise authenticate with one or more access devices 130 to enable user verification using the UV models 125. For example, the participating device 105 (or another system) may use a provided link or other technique to register with a given access device 130, sharing their (obfuscated) identifier/embedding to be stored as an authenticated embedding. To authenticate a user, each access device 130 can receive an identifying signal from the user (e.g., a fingerprint), process the identifying signal using the UV model 125 to generate an embedding, and compare this generated embedding with the set of authorized or authenticated embeddings to determine whether to grant access (or perform some other output). In this way, a wide variety of access devices 130 can use UV models 125, trained on data specifically for each user without exposing the user's secure data, to provide user verification and authentication without requiring the user specifically enroll or train the model for or on the specific access device 130.

In some aspects, to register (and de-register) users, the set of authenticated embeddings can be readily updated (adding and removing embeddings appropriately) without the need to retrain or refine the UV models 125. For example, in the case of an access device 130 corresponding to a smart door lock (e.g., on a hotel door), a new authorized user can be added to the system by simply registering or adding the user's identifier embedding with the access device 130. If the user should subsequently be removed, then the user's identifier embedding can be de-registered or removed from the authorized list. In this way, the access device 130 need not be owned or controlled by the user, need not receive identifying information of the user during enrollment, and need not participate in model training, but can still use a personally trained UV model 125 for the user.

In some aspects, the workflow 100 may be repeated periodically or upon occurrence of defined event(s). For example, when a new user wishes to participate in the workflow 100, the new user may participate in a new round (or multiple rounds) of federated learning (generating and sending model updates 115 using the user's trusted participating device 105). In some aspects, each time a new user successfully participates or at a certain time (e.g., hourly, daily, etc.), the central server 120 can push the new global UV model 125 to the access devices 130. In at least one aspect, each time a new identifying signal or authentication request is received, the access device 130 may determine whether there is an updated UV model 125 (e.g., via query or request to the central server 120). This allows each access device 130 to remain updated with any new users and models.

### Example Workflow for Private and Secure Inferencing Using Machine Learning Models

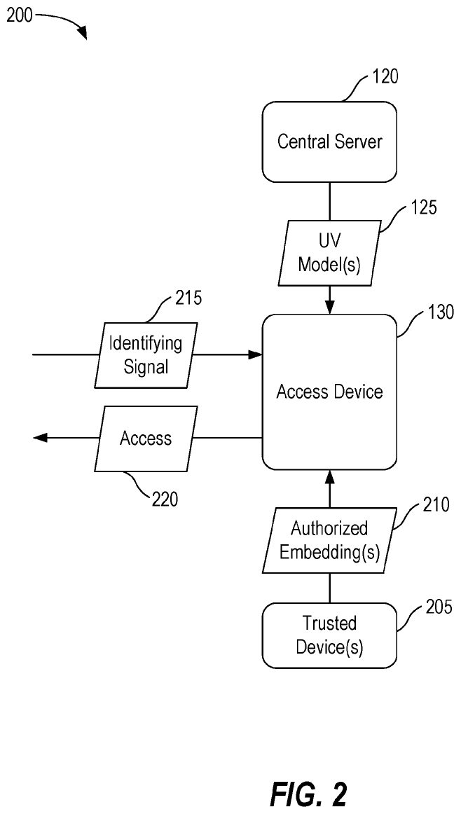

FIG. 2 depicts an example workflow 200 for private and secure inferencing using machine learning models.

In the illustrated example, an access device 130 receives or accesses one or more UV models 125 from a central server 120. For example, as discussed above, the central server 120 may use a secure or privacy-enhanced federated learning operation to allow users to jointly train the UV model 125 to generate embeddings based on input data, where these embeddings can be used to verify or authenticate the user and/or the input data. As discussed above, the access device 130 need not be a trusted device (though the access device 130 may be a trusted device of one or more users in some aspects) and need not engage or participate in the training of the UV model 125 (though the access device 130 may participate in the training in some aspects).

As illustrated, the access device 130 can additionally receive one or more authorized embeddings 210 directly or indirectly from one or more trusted devices 205. As discussed above and in more detail below, the authorized embeddings 210 generally correspond to users that are authorized to access or use the access device 130 (or to access or use resources that the access device 130 protects). For example, if the access device 130 corresponds to a security system in an office, then the authorized embeddings 210 may correspond to employees who work in the office.

The trusted device(s) 205 generally correspond to computing devices that are used, owned, maintained, controlled, or otherwise trusted by one or more users that participated or are enrolled in the training of the UV model 125. For example, the trusted device(s) 205 may include (but are not limited to) smartphones, laptops, and the like of each individual user. In at least one aspect, some or all of the trusted device(s) 205 may correspond to participating device(s) 105 that participated in the training process of the UV model 125. In the illustrated example, as each trusted device 205 can provide the authorized embedding 210 directly or indirectly to the access device 130, the central server 120 need not receive or access the authorized embeddings 210. This enhances security and privacy.

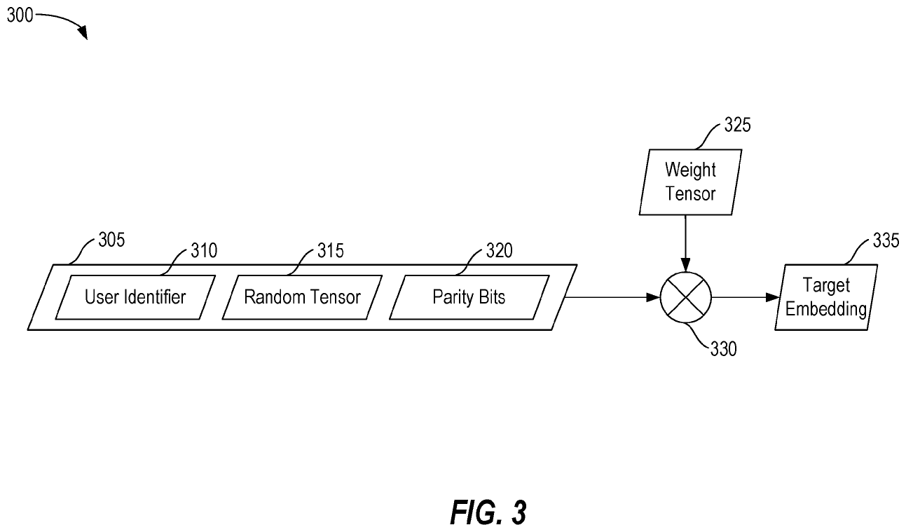

Generally, the authorized embeddings 210 may be provided to or accessed by the access device 130 using a variety of techniques. For example, in some aspects, users can register with the access device 130 in any suitable manner (e.g., by using a link provided by an entity that controls the access device 130) and provide their identifier embedding (e.g., generated based on a user identifier as discussed above and in more detail below with reference to FIG. 3). This embedding can then be stored as an authorized embedding (by the access device 130, or by another system or device).

In some aspects, the access device 130 accesses the authorized embeddings 210 using a trusted and/or encrypted local or personal network (e.g., a wireless local area network (WLAN) such as a WiFi network, Bluetooth, etc.). For example, each authorized user may use a personal device (e.g., a trusted device 205) to provide their identifier embedding directly to the access device 130 via a secure local network.

In some aspects, the access device 130 may access the authorized embeddings 210 from a secure network location. For example, the user may use a trusted device to upload their identifier embedding to a secure network location (e.g., in the cloud) using a secure, encrypted, or otherwise trusted connection. The access device 130 can then access or retrieve the embedding (e.g., using a username and password) via a trusted or encrypted network. In this way, authorized embeddings 210 are provided securely.

In some aspects, the access device 130 (or another device that stores the authorized embeddings 210 on behalf of the access device 130) uses encryption or other secure mechanisms to store or maintain the authorized embeddings 210. For example, upon receiving an authorized embedding 210, the access device 130 may encrypt the embedding and store the encrypted embedding in a secure location. When a verification request is subsequently received, the access device 130 may decrypt the stored authorized embedding(s) 210 to compare against the verification request, before re-encrypting the authorized embeddings 210 (or deleting the decrypted embeddings) for security. In some aspects, the decryption and comparison process can be performed by the access device 130 within a trusted execution environment (TEE) (e.g., one or more separate hardware components), such that the embeddings cannot be read, decrypted, or otherwise accessed or extracted from the access device 130.

In the illustrated workflow 200, the access device 130 receives or accesses identifying signals 215 for verification. The identifying signal 215 may generally be received or accessed in a wide variety of manners. For example, the identifying signal 215 may be provided by another device or system (e.g., transmitted by a trusted device 205), or the identifying signal 215 may be input directly to the access device 130 (e.g., the access device 130 may include one or more sensors, such as imaging sensors, audio sensors, fingerprint sensors, and the like to capture the identifying signals 215). In some aspects, when the identifying signal(s) 215 are received, identifying signal(s) 215 may be provided without indication or identification of the corresponding user with which the signals are associated.

As discussed above, the access device 130 may process the received identifying signal 215 using the UV model 125 to generate an embedding and compare this embedding against the stored authorized embeddings 210 in order to determine whether to verify or authenticate the identifying signal 215 (and, therefore, to authenticate or verify the user that provided the signal). In some aspects, the access device 130 verifies the identifying signal 215 by computing or determining the distance (in the embedding space) between the generated embedding and each authorized embedding 210 and comparing this distance to one or more thresholds.

In some aspects, the access device 130 uses a fixed and/or global threshold distance (e.g., defined by the central server 120, defined by the entity that owns or controls the access device 130, or defined by another entity) to determine whether the generated embedding is sufficiently close to an authorized embedding 210. This may allow the owner of the access device 130 to configure how secure the system is (e.g., by setting a small threshold, causing more inputs to be rejected). In some aspects, the threshold distance may be a user-configurable value. For example, when providing the authorized embedding 210 during registration, the trusted device 205 may further specify the threshold distance that should be used when comparing generated embeddings to the provided authorized embedding 210. In this way, each user may selectively set higher or lower thresholds, where lower threshold distances (corresponding to higher threshold similarities) will tend to reduce false-positives (e.g., reduced probability that a non-authorized user will be mistaken for the user of the trusted device 205) but may result in more false-negatives (e.g., where the authorized user is mistakenly rejected or denied access).

In at least one aspect, each user sets their respective threshold distance based on their own identifying signals used in training or validating the UV model 125. For example, the trusted device 205 or participating device may set the threshold such that a fixed percentage of the testing samples of the user (e.g., 90%) result in a pass or verification, while the remaining samples (e.g., the remaining 10%) result in a denial.

In the illustrated example, if the access device 130 determines that the embedding generated using the identifying signal 215 is sufficiently close to an authorized embedding 210 (e.g., within the global or user-specific distance), then the access device 130 can grant or provide access 220 to the user. As used herein, access 220 may generally include a wide variety of output or actions, including providing secured or protected data to the user, providing access to the access device 130 itself, providing physical access to a space or object (e.g., unlocking a door), and the like. In some aspects, if the access device 130 determines that the embedding is not sufficiently close to any of the authorized embeddings 210, then a variety of actions can be taken depending on the particular implementation, including rejecting or denying access 220, generating an alert or alarm, and the like.

In some aspects, whenever a new UV model 125 is available (e.g., trained for a new user), the central server 120 can push the updated model to the access device 130 or otherwise notify the access device 130 that the updated UV model 125 is ready for deployment. In some aspects, the access device 130 can request or check for an updated UV model 125 periodically or upon the occurrence of specified criteria or events. For example, in some aspects, when an identifying signal 215 is received, the access device 130 may determine whether a new model is available prior to processing the identifying signal 215. In some aspects, if the access device 130 fails to find a sufficiently close authorized embedding 210, then the access device 130 can check to see if there is a new UV model 125 that should be used.

Similarly, in some aspects, the access device 130 can determine whether an updated set of authorized embeddings 210 is available periodically (e.g., daily) or upon the occurrence of specified events or criteria (e.g., when an identifying signal 215 is received, when the access device 130 fails to verify the identifying signal 215, and the like).

In this way, the access device 130 can use trained UV models 125 (which were trained using specific private and secure data for specific authorized users, without exposing the private or secure data to other devices) to dynamically verify or authenticate users that may have no ownership or control over the access device 130. Similarly, although the users can enroll a single time using one trusted device, the UV model 125 can be deployed to a wide variety and number of access devices 130, enabling the enhanced user verification techniques to be rapidly and easily deployed. Moreover, as authorization can be updated by simply updating the set of authorized embeddings 210 (without retraining or refining the UV model 125), the system can respond rapidly to changing conditions or events.

### Example Workflow for Generating Authorized Embeddings to Enable Private and Secure Machine Learning

FIG. 3 depicts an example workflow 300 for generating authorized embeddings to enable private and secure machine learning. In some aspects, the workflow 300 can be performed by user devices that are participating in secure federated learning operations, such as participating devices 105 of FIG. 1. In some aspects, the workflow 300 can be performed by user devices that desire to register with or use access devices that use trained UV models, such as the trusted device 205 of FIG. 2.

Generally, the workflow 300 is used to generate a target embedding 335. As discussed above and in more detail below, the target embedding 335 may be used for a variety of purposes, including training of UV models (e.g., where the target embedding 335 is used as the target or ground-truth label during training), registering with access-controlled devices (e.g., where the target embedding 335 is provided or stored as an authorized embedding against which newly generated embeddings are compared), and the like.

In the illustrated example, a user-specific tensor 305 is generated. In some aspects, the user-specific tensor 305 may be based on a user identifier 310, a random tensor 315, and a set or parity bits 320. In some aspects, the user identifier 310 is a unique identifier (e.g., a vector or tensor having a unique set of values) that can be used to uniquely identify a specific user. In at least one aspect, the user identifier 310 is assigned by a central system that facilitates the federated learning of UV models, such as the central server 120 of FIG. 1. For example, when a new user enrolls or begins participating in the training process, the central server 120 may assign the unique user identifier 310 to the user and/or to the user's participating device. This user identifier 310 ensures that the user-specific tensor 305 is globally unique.

In at least one aspect, the random tensor 315 can be selected by the user (or by the user's participating device) using a variety of techniques, including randomly or pseudo-randomly. For example, the user's device may select a set of values for a vector or tensor of a variable or defined length to serve as the random tensor 315. This random tensor 315 can thereby obfuscate the unique user identifier 310 and/or the user-specific tensor 305, as the random tensor 315 may be known to the user or user device, but unknown (e.g., not shared or accessed by) other devices (e.g., other participating systems or the central server).

In the illustrated example, the parity bits 320 are generated using one or more error correcting code (ECC) algorithms or operations. Generally, ECC techniques enable the restoration of sequences of data from noise and are designed to maximize the distance between distinct sequences (e.g., between user identifiers 310 and/or random tensors 315). That is, the parity bits 320 may be generated based on the user identifier 310 and/or random tensor 315 using one or more ECC techniques (e.g., using Bose-Chaudhuri-Hocquenghem codes (BCH codes)), such that the parity bits 320, when added to the user identifier 310 and/or random tensor 315, act to maximize the distance between the user-specific tensor 305 associated with one user and the user-specific tensors 305 of all other users.

In this way, as discussed above, the parity bits 320 enable the UV models to be trained more accurately and efficiently even when only positive exemplars on each participating device are available, as the user-specific tensors 305 (and therefore, the resulting embeddings) from different users may be substantially (or even maximally) separated from each other. As illustrated, the user identifier 310, random tensor 315, and parity bits 320 are aggregated to form the user-specific tensor 305. For example, the user identifier 310, random tensor 315, and parity bits 320 may be concatenated to form the user-specific tensor 305.

In some aspects, the user-specific tensor 305 may be referred to as hidden, secret, or obfuscated due at least in part to the random tensor 315. In some aspects, to further obfuscate the user-specific tensor 305 (thereby protecting the identity of the user) and/or enable improved model training, the user-specific tensor 305 is aggregated with a weight tensor 325 (e.g., a matrix of weights or values) learned during the training process using an operation 330. As discussed above, the weight tensor 325 generally corresponds to a set of weights that are learned during training of the UV model (e.g., using gradient descent). In this way, during each round of training, the weight tensor 325 may change (and, therefore, the target embedding 335 may change). For example, the parameters of the weight tensor 325 may be updated locally by each participating device, and the central server may aggregate these updates and distribute the updated weight tensor (along with the updated UV model) for the next round of training. In the illustrated example, the operation 330 is a multiplication operation (e.g., where the user-specific tensor 305 is combined with the weight tensor 325 using matrix multiplication).

In at least one aspect, the user identifier 310, random tensor 315, and parity bits 320 can each be binary vectors. That is, the user identifier 310, random tensor 315, and parity bits 320 may each be a vector where each value is either a zero or a one. In some aspects, prior to applying the operation 330, the system can replace all values of zero in the user-specific tensor 305 with a defined value, such as negative one. This new user-specific tensor 305 (where all values are either-1 or 1) can then be processed (e.g., using the operation 330) to yield the target embedding 335. In this way, the expected embedding value of the target embedding 335 is zero. That is, if the original user-specific tensor 305 (with values of zero or one) was used, then the expected embedding would be positive (greater than zero) and the learning problem may become asymmetric. By replacing the values of zero with a value of negative one, the problem may become more symmetric.

As discussed above, the target embedding 335 can then be used for a variety of operations. For example, during training, the target embedding 335 can be used as the target label or ground-truth for the user's identifying signals. In this way, the UV model learns to cluster embeddings based on the identity of the user providing the identifying signal. That is, the machine learning model learns to generate embeddings, based on identifying signals, where the embeddings that correspond to a first user will tend to be clustered or relatively near to each other in the embedding space and near to the target embedding 335, while embeddings from other users will tend to move away from or be separated from the embeddings of the first user. Note, however, that the embeddings for each other user will tend to remain clustered near each other, and near the respective target embedding of the other user, even while the embeddings of each user separate from each other.

As discussed above, once the model is trained, the target embedding 335 can further be used to register with access devices in order to enable user verification. In some aspects, the user's device (e.g., a trusted device 205 of FIG. 2) stores the target embedding 335 in a secure location (e.g., in an encrypted storage) for use with any future registrations. For example, each time the user desires to register with a new access device, the target embedding 335 can be decrypted and transmitted or otherwise provided to the access device, where the target embedding can be stored as an authorized embedding, as discussed above.

### Example Method for Private and Secure Training and Deployment of Machine Learning Models

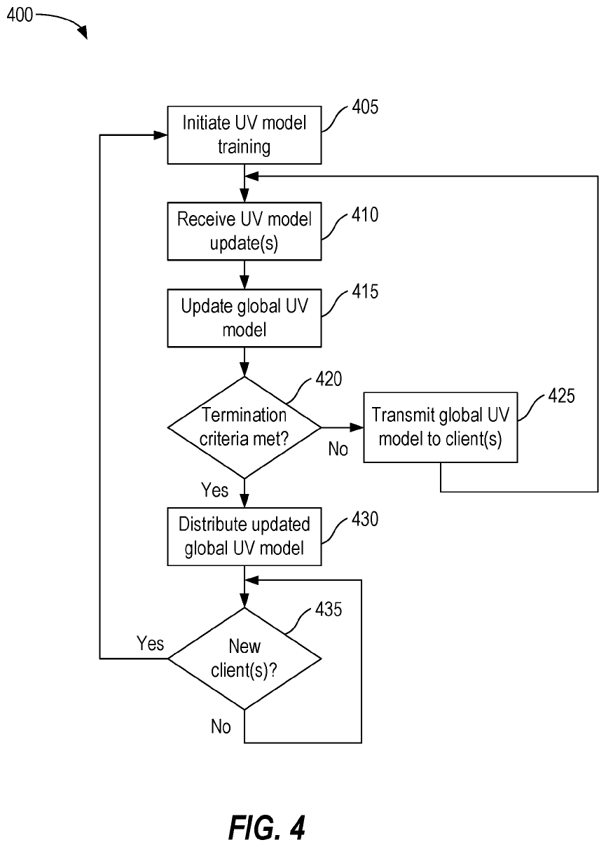

FIG. 4 is a flow diagram depicting an example method 400 for private and secure training and deployment of machine learning models. In some aspects, the method 400 is performed by a central server, such as the central server 120 of FIG. 1. In one aspect, the method 400 provides additional detail for the workflow 100 of FIG. 1.

At block 405, the central server initiates training of a UV model using federated learning. For example, the central server may identify the set of participating users (e.g., participating devices 105 of FIG. 1) that wish to enroll in or otherwise assist with the training of the UV model. In some aspects, initiating the training may be performed responsive to a variety of occurrences or criteria, such as periodically, upon determining that a new user wishes to enroll, and the like. In some aspects, initiating the training can include transmitting data to each device, such as the current version of the UV model (which may include a weight tensor used to obfuscate identifying tensors, as discussed above), hyperparameters or information related to the training (e.g., indicating the learning rate), a trigger to initiate local training on each participating device, a unique identifier for each user (e.g., user identifier 310 of FIG. 3) and the like.

In some aspects, in response to receiving this initiation, each participating device can train a local version of the UV model, as discussed above. For example, each participating device may generate a local target embedding (e.g., as discussed above with reference to FIG. 3), and access or collect a set of identifying signals (e.g., identifying signals 110 of FIG. 1), such as by capturing images, audio, or other identifying data from the user. Each participating device can then process the identifying data using the model to generate an embedding, and generate a loss based on the difference between the embedding and the target embedding. This loss can then be used to update the UV model parameters (e.g., using backpropagation).

At block 410, the central server receives UV model updates (e.g., model updates 115 of FIG. 1) from each participating device. As discussed above, these model updates may generally include updated parameters for the UV model (which may include updated parameters for a weight tensor used to generate the target embeddings), gradients indicating how the parameters should be updated, and/or the like.

At block 415, the central server updates a global UV model based on the received model updates from each participating device. That is, the central server can aggregate the model updates from each individual participant in order to update or generate a global version of the UV model. For example, the central server may compute the average, sum, weighted average, mean, median, and the like for each parameter or gradient, and use these values to update or generate the updated global model.

At block 420, the central server determines whether one or more training termination criteria are satisfied. In some aspects, the central server may determine whether training is complete based on a wide variety of termination criteria, including a defined number of rounds or epochs of training, an amount of time or resources spent training, a desired model accuracy (e.g., determined using test data), and the like. If, at block 420, the central server determines that the termination criteria are not met, then the method 400 continues to block 425, where the central server transmits the updated global UV model (and, in some aspects, the updated weight tensor) to each participating client. In this way, the federated learning operation begins a new round of training, and the method 400 then returns to block 410.

If, at block 420, the central server determines that the termination criteria are satisfied, then the method 400 continues to block 430, where the central server distributes or deploys the updated global UV model to one or more access devices (e.g., access devices 130 of FIG. 1 and/or FIG. 2). For example, the central server may identify any access devices that use the UV model, and distribute the updated version to each.

In some aspects, this distribution of the UV model can include informing one or more of the access devices that a new version is available and allowing the access device(s) to request the updated model. In some aspects, the central server may distribute the UV model by making the model available for request, rather than immediately providing the UV model to each access device (e.g., where access devices request the updated model periodically or according to other criteria). As discussed above, the access devices can then use this updated model to perform reliable user verification with enhanced security and privacy protections for the users.

At block 435, the central server determines whether there are one or more new clients or users that desire to enroll in the system (e.g., to assist in training the UV model, such that the UV model can be used to verify or authenticate the client). If not, then the method 400 iterates at block 435. If there is at least one new client (or other criteria, such as a periodic retraining, are met), then the method 400 returns to block 405 to initiate a new round of UV model training.

In this way, the central server can use a secure and private federated learning technique to train the UV model using user-specific data on trusted devices and distribute the model to various (untrusted) devices for runtime inferencing.

### Example Method for Private and Secure Inferencing Using Machine Learning Models

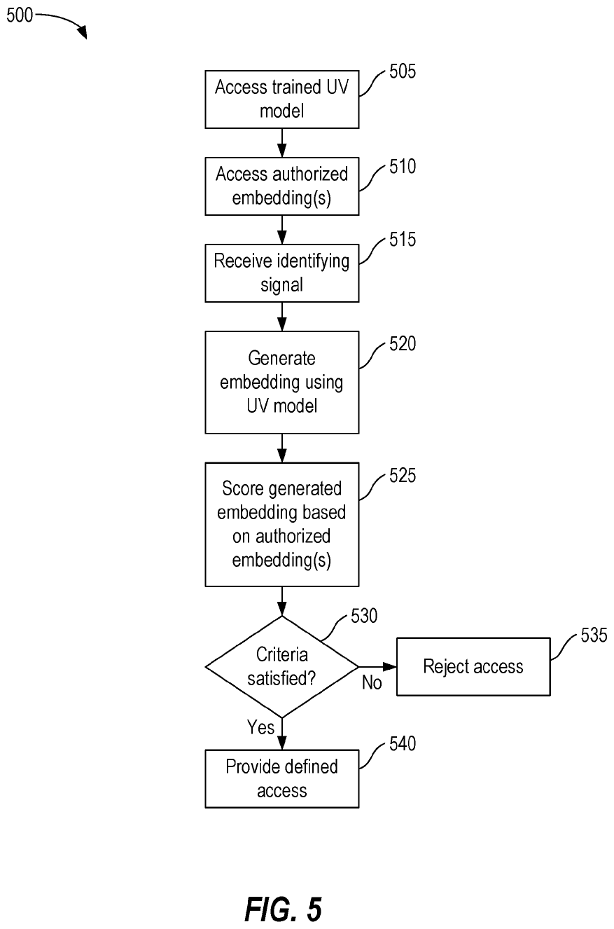

FIG. 5 is a flow diagram depicting an example method 500 for private and secure inferencing using machine learning models. In some aspects, the method 500 is performed by an access device, such as the access device 130 of FIG. 2. In some aspects, the method 500 provides additional detail for the workflow 200 of FIG. 2.

At block 505, the access device accesses a trained UV model. For example, as discussed above, the access device may retrieve or receive the UV model from a central server, such as the central server 120 of FIGS. 1 and 2. In some aspects, as discussed above, the UV model is trained using a secure federated learning operation that allows each participating user to retain their identifying information (e.g., identifying signals and/or user-specific tensors) securely on their local devices, while still enabling training of the UV model. As discussed above, the access device may generally access the UV model according to a variety of criteria, including periodically, upon determining that a new model is available, upon determining that a new user has registered with the access device (e.g., in response to receiving an authorized embedding from a new user that was not previously registered), and the like.

At block 510, the access device accesses a set of authorized embeddings (e.g., authorized embeddings 210 of FIG. 2). For example, as discussed above, the access device may retrieve or receive the authorized embeddings from trusted user devices during a registration process. In some aspects, as discussed above, the authorized embeddings correspond to target embeddings, such as the target embeddings 335 generated using the workflow 300 of FIG. 3.

In some aspects, as discussed above, the access device may access the target embeddings directly from the trusted devices (e.g., using a secure or encrypted local network), indirectly (e.g., via a trusted or encrypted cloud location), and the like. In some aspects, after receiving the authorized embeddings, the access device can store the authorized embeddings in a secure (e.g., encrypted) location for future use. In at least one aspect, accessing the authorized embeddings can include determining whether any previously stored embeddings are no longer authorized. For example, the access device may determine whether the user has de-registered, whether another entity (e.g., the entity that controls, owns, or operates the access device) de-listed or de-registered any embeddings or users, and the like.

In some aspects, the access device accesses the authorized embeddings periodically, or in response to other criteria. For example, the access device may request an updated set of authorized embeddings in response to receiving a new UV model, in response to receiving an identifying signal that cannot be verified, in response to receiving any identifying signal (e.g., before evaluating the signal using the UV model), and the like.

At block 515, the access device receives an identifying signal for a user. As discussed above, the identifying signal can generally include any information, data, or characteristics that can be used to identify the user, such as biometric data (e.g., fingerprints or eye scans), facial images or scans, audio (such as voice or speech recordings), gestures or other physical movement, and the like.

Generally, the access device may receive the identifying signal using a variety of techniques depending on the particular implementation. For example, the access device may receive the identifying signal directly (e.g., via one or more sensors of the access device), or may receive the signal from another device or system.

At block 520, the access device generates an embedding by processing the identifying signal using the accessed UV model. As discussed above, this embedding is generally a multidimensional vector or tensor. If each value in the embedding is used as the coordinate of a corresponding dimension in a multidimensional embedding space, then the access device can thereafter identify similar embeddings (e.g., those that are within a defined distance in the embedding space).

At block 525, the access device generates a score for the generated embedding based on the stored set of authorized embeddings. In one such aspect, the access device scores the generated embedding by computing the distance (e.g., the Euclidean distance) between the generated embedding and each stored embedding, where the score may indicate, for example, the distance to at least the nearest authorized embedding in the embedding space.

At block 530, the access device can determine whether the generated score satisfies one or more defined criteria. For example, the access device may determine whether the score (e.g., the distance) satisfies one or more defined minimum distance thresholds. In some aspects, as discussed above, the distance threshold is defined globally (e.g., where data from all users are compared to the same threshold). In at least one aspect, the thresholds are user-specific and/or user-defined (e.g., where each stored authorized embedding is associated with a corresponding distance criteria or threshold). For example, the user (or user device) may set the threshold to ensure that a specified percentage of their training or test samples are accurately classified, or the user (or user device) may set the threshold based on personal or institutional preference with respect to false positives and false negatives.

If, at block 530, the access device determines that the criteria are not satisfied, the method 500 continues to block 535, where the access device rejects access. That is, the access device determines that the user is not authorized (or that the identifying signal cannot be verified), and therefore rejects or denies access. As discussed above, rejecting access can generally include a variety of operations depending on the particular implementation. For example, the access device may refrain from opening a physical space or lock, refrain from providing secured data or access to the device, generate an alert or alarm, and the like.

If, at block 530, the access device determines that the criteria are satisfied, the method 500 continues to block 540, where the access device provides the defined access to the user. As discussed above, providing or granting access can generally include a variety of operations depending on the particular implementation. For example, the access device may open or unlock a physical device or object (e.g., a smart lock), provide defined data, provide access to the access device, and the like.

### Example Method for Securely Using Machine Learning Models

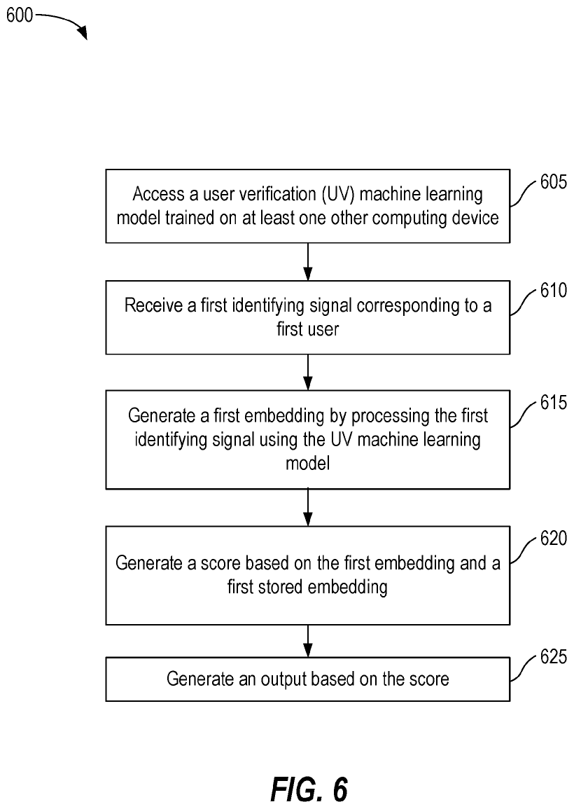

FIG. 6 is a flow diagram depicting an example method 600 for securely using machine learning models. In some aspects, the method 600 is performed by an access device, such as the access device 130 of FIG. 2.

At block 605, a user verification (UV) machine learning model trained on at least one other computing device is accessed.

At block 610, a first identifying signal corresponding to a first user is received.

At block 625, a first embedding is generated by processing the first identifying signal using the UV machine learning model.

At block 620, a score is generated based on the first embedding and a first stored embedding.

At block 625, an output is generated based on the score.

In some aspects, the at least one other computing device is an untrusted device, with respect to the first computing device.

In some aspects, the UV machine learning model was trained at least in part using a federated learning operation performed by a trusted computing device of the first user, the at least one other computing device, and a central server, the federated learning operation was performed based on at least one identifying signal corresponding to the first user, and the at least one identifying signal is unavailable at the central server.

In some aspects, the federated learning operation comprises: generating a training embedding by processing a training identifying signal corresponding to the first user using a version of the UV machine learning model; generating a target embedding by aggregating a user-specific tensor and a weight tensor, wherein the weight tensor is learned during the federated learning operation; and generating a loss based on the training embedding and the target embedding.

In some aspects, the UV machine learning model is further distributed to a plurality of computing devices to perform user verification for a plurality of users.

In some aspects, the method 600 further includes receiving the first stored embedding from a trusted computing device of the first user via a trusted communication link.

In some aspects, the method 600 further includes receiving an encrypted first embedding from a secure network location, wherein the encrypted first embedding was transmitted to the secure network location by a trusted computing device of the first user, and decrypting the encrypted first embedding.

In some aspects, the method 600 further includes receiving an updated UV machine learning model, trained using a federated learning operation performed in part by a trusted computing device of a second user; receiving a second identifying signal corresponding to the second user; generating a second embedding by processing the second identifying signal using the updated UV machine learning model.

In some aspects, the first stored embedding was generated, by a trusted device of the first user, by aggregating a user-specific tensor and a weight tensor, wherein the weight tensor was learned during training of the UV machine learning model.

In some aspects, generating the score comprises: computing a distance between the first embedding and the first stored embedding; and determining whether the distance satisfies a defined distance threshold.

In some aspects, generating the output based on the score comprises, in response to determining that the score satisfies one or more defined criteria, granting the first user access to a secured entity.

In some aspects, the secured entity is the first computing device or a physical space.

In some aspects, the first stored embedding is one of a plurality of stored embeddings. The plurality of stored embeddings (including the first stored embedding) may be stored on the first computing device.

In some aspects, the first identifying signal comprises biometric data of the first user.

### Example Method for Securely Training Machine Learning Models

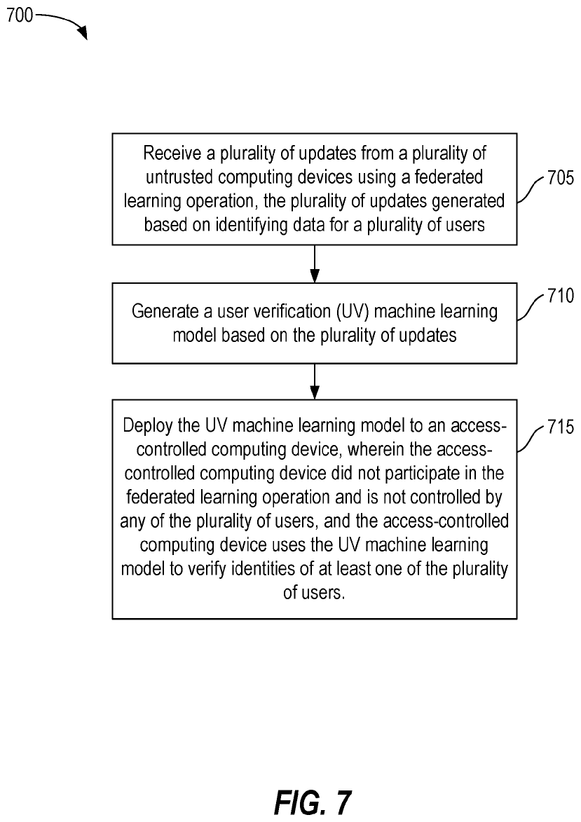

FIG. 7 is a flow diagram depicting an example method 700 for securely training machine learning models. In some aspects, the method 700 is performed by a central server, such as the central server 120 of FIG. 1.

At block 705, a plurality of updates is received from a plurality of untrusted computing devices using a federated learning operation, the plurality of updates generated based on identifying data for a plurality of users.

At block 710, a user verification (UV) machine learning model is generated based on the plurality of updates At block 715, the UV machine learning model is deployed to an access-controlled computing device, wherein the access-controlled computing device did not participate in the federated learning operation and is not controlled by any of the plurality of users, and the access-controlled computing device uses the UV machine learning model to verify identities of at least one of the plurality of users.

In some aspects, the method 700 further includes deploying the UV machine learning model to a plurality of access-controlled computing devices.

In some aspects, the identifying data for the plurality of users is unavailable on the central server.

### Example Processing System for Training and Deploying Machine Learning Models

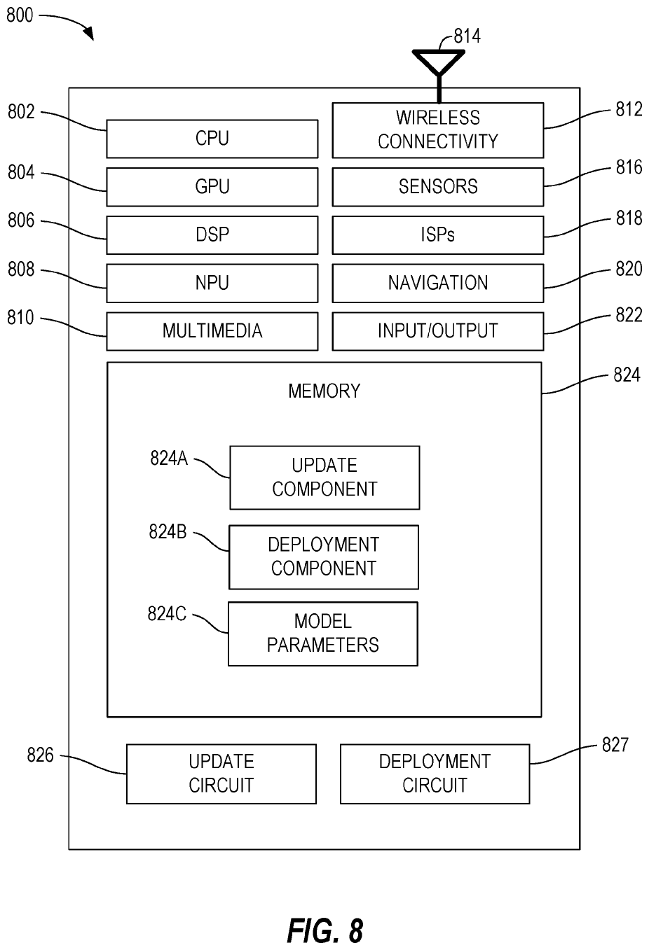

In some aspects, the workflows, techniques, and methods described with reference to FIGS. 1-7 may be implemented on one or more devices or systems. FIG. 8 depicts an example processing system 800 configured to perform various aspects of the present disclosure, including, for example, the techniques and methods described with respect to FIGS. 1-7. In one aspect, the processing system 800 may correspond to a central server, such as the central server 120 of FIGS. 1 and 2. Although depicted as a single system for conceptual clarity, in at least some aspects, as discussed above, the operations described below with respect to the processing system 800 may be distributed across any number of devices.

Processing system 800 includes a central processing unit (CPU) 802, which in some examples may be a multi-core CPU. Instructions executed at the CPU 802 may be loaded, for example, from a program memory associated with the CPU 802 or may be loaded from a partition of memory 824.

Processing system 800 also includes additional processing components tailored to specific functions, such as a graphics processing unit (GPU) 804, a digital signal processor (DSP) 806, a neural processing unit (NPU) 808, a multimedia processing unit 810, and a wireless connectivity component 812.

An NPU, such as 808, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In one implementation, NPU 808 is a part of one or more of CPU 802, GPU 804, and/or DSP 806.

In some examples, wireless connectivity component 812 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 812 is further connected to one or more antennas 814.

Processing system 800 may also include one or more sensor processing units 816 associated with any manner of sensor, one or more image signal processors (ISPs) 818 associated with any manner of image sensor, and/or a navigation component 820, which may include satellite-based positioning system components (e.g., GPS or GLONASS) as well as inertial positioning system components.

Processing system 800 may also include one or more input and/or output devices 822, such as screens, touch-sensitive surfaces (including touch-sensitive displays), physical buttons, speakers, microphones, and the like.

In some examples, one or more of the processors of processing system 800 may be based on an ARM or RISC-V instruction set.

Processing system 800 also includes memory 824, which is representative of one or more static and/or dynamic memories, such as a dynamic random access memory, a flash-based static memory, and the like. In this example, memory 824 includes computer-executable components, which may be executed by one or more of the aforementioned processors of processing system 800.

In particular, in this example, memory 824 includes an update component 824A and a deployment component 824B, as well as model parameters 824C. Though depicted as discrete components for conceptual clarity in FIG. 8, the illustrated components (and others not depicted) may be collectively or individually implemented in various aspects.

The model parameters 824C may generally correspond to the parameters of one or more UV models (e.g., UV model 125 of FIGS. 1 and 2), as discussed above. For example, the model parameters 824C may include weights of a neural network, weights for a weight tensor used to generate target embeddings, and the like.

Processing system 800 further comprises update circuit 826 and deployment circuit 827. The depicted circuits, and others not depicted, may be configured to perform various aspects of the techniques described herein.

For example, update component 824A and update circuit 826 may be used to facilitate federated learning and aggregate model updates (from participating devices) to generate updated global UV models, as discussed above. Deployment component 824B and deployment circuit 827 may be used to deploy or distribute updated global UV models to access devices, as discussed above.

Though depicted as separate components and circuits for clarity in FIG. 8, update circuit 826 and deployment circuit 827 may collectively or individually be implemented in other processing devices of processing system 800, such as within CPU 802, GPU 804, DSP 806, NPU 808, and the like.

Generally, processing system 800 and/or components thereof may be configured to perform the methods described herein.

Notably, in other aspects, aspects of processing system 800 may be omitted, such as where processing system 800 is a server computer or the like. For example, multimedia processing unit 810, wireless connectivity component 812, sensor processing units 816, ISPs 818, and/or navigation component 820 may be omitted in other aspects. Further, aspects of processing system 800 maybe distributed between multiple devices.

### Example Processing System for Inferencing Using Machine Learning Models

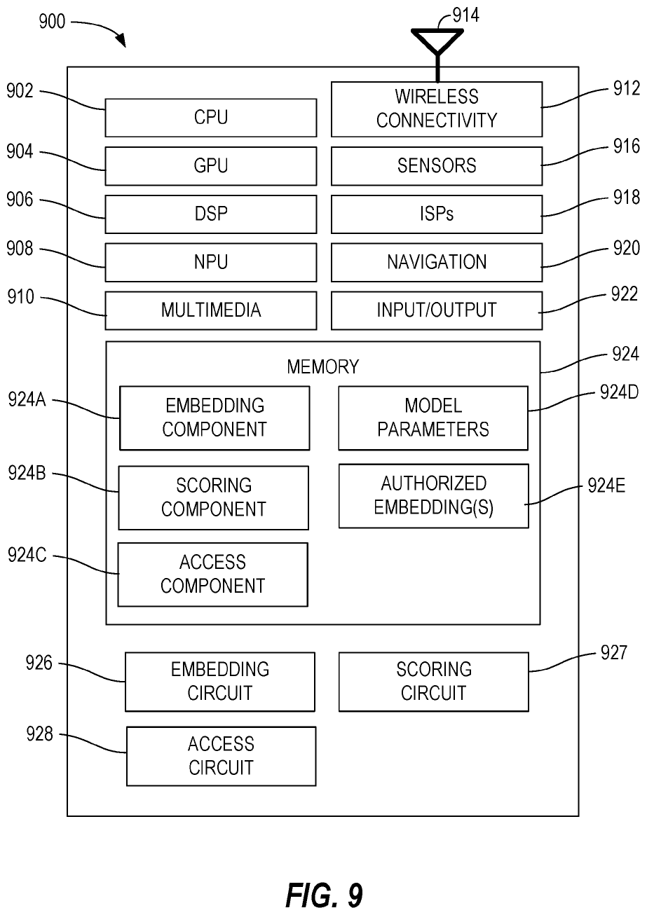

In some aspects, the workflows, techniques, and methods described with reference to FIGS. 1-7 may be implemented on one or more devices or systems. FIG. 9 depicts an example processing system 900 configured to perform various aspects of the present disclosure, including, for example, the techniques and methods described with respect to FIGS. 1-7. In one aspect, the processing system 900 may correspond to an access device, such as the access device 130 of FIGS. 1 and 2. Although depicted as a single system for conceptual clarity, in at least some aspects, as discussed above, the operations described below with respect to the processing system 900 may be distributed across any number of devices.

Processing system 900 includes a central processing unit (CPU) 902, which in some examples may be a multi-core CPU. Instructions executed at the CPU 902 may be loaded, for example, from a program memory associated with the CPU 902 or may be loaded from a partition of memory 924.

Processing system 900 also includes additional processing components tailored to specific functions, such as a graphics processing unit (GPU) 904, a digital signal processor (DSP) 906, a neural processing unit (NPU) 908, a multimedia processing unit 910, and a wireless connectivity component 912.

An NPU, such as 908, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as 908, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In one implementation, NPU 908 is a part of one or more of CPU 902, GPU 904, and/or DSP 906.

In some examples, wireless connectivity component 912 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 912 is further connected to one or more antennas 914.

Processing system 900 may also include one or more sensor processing units 916 associated with any manner of sensor, one or more image signal processors (ISPs) 918 associated with any manner of image sensor, and/or a navigation component 920, which may include satellite-based positioning system components (e.g., GPS or GLONASS) as well as inertial positioning system components.

Processing system 900 may also include one or more input and/or output devices 922, such as screens, touch-sensitive surfaces (including touch-sensitive displays), physical buttons, speakers, microphones, and the like.

In some examples, one or more of the processors of processing system 900 may be based on an ARM or RISC-V instruction set.

Processing system 900 also includes memory 924, which is representative of one or more static and/or dynamic memories, such as a dynamic random access memory, a flash-based static memory, and the like. In this example, memory 924 includes computer-executable components, which may be executed by one or more of the aforementioned processors of processing system 900.

In particular, in this example, memory 924 includes an embedding component 924A, a scoring component 924B, and an access component 924C, as well as model parameters 924D and authorized embeddings 924E. Though depicted as discrete components for conceptual clarity in FIG. 9, the illustrated components (and others not depicted) may be collectively or individually implemented in various aspects.

The model parameters 924D may generally correspond to the parameters of one or more UV models (e.g., UV model 125 of FIGS. 1 and 2), as discussed above. For example, the model parameters 924D may include weights of a neural network, weights for a weight tensor used to generate target embeddings, and the like. The authorized embeddings 924E generally correspond to a set of target embeddings for users who are authorized access to the access device (e.g., obtained during a registration process), as discussed above.

Processing system 900 further comprises embedding circuit 926, scoring circuit 927, and access circuit 928. The depicted circuits, and others not depicted, may be configured to perform various aspects of the techniques described herein.

For example, embedding component 924A and embedding circuit 926 may be used to generate embeddings by processing received identifying signals or data using trained UV models, as discussed above. Scoring component 924B and scoring circuit 927 may be used to generate scores (e.g., distances) for generated embeddings based on the stored set of authorized embeddings 924E, as discussed above. Access component 924C and access circuit 928 may be used to selectively grant or deny access to users (e.g., based on the generated scores and one or more thresholds), as discussed above.

Though depicted as separate components and circuits for clarity in FIG. 9, embedding circuit 926, scoring circuit 927, and access circuit 928 may collectively or individually be implemented in other processing devices of processing system 900, such as within CPU 902, GPU 904, DSP 906, NPU 908, and the like.

Generally, processing system 900 and/or components thereof may be configured to perform the methods described herein.

Notably, in other aspects, aspects of processing system 900 may be omitted, such as where processing system 900 is a server computer or the like. For example, multimedia processing unit 910, wireless connectivity component 912, sensor processing units 916, ISPs 918, and/or navigation component 920 may be omitted in other aspects. Further, aspects of processing system 900 maybe distributed between multiple devices.

### Example Clauses

Implementation examples are described in the following numbered clauses:
Clause 1: A method comprising: accessing, by a first computing device, a user verification (UV) machine learning model trained on at least one other computing device; receiving a first identifying signal corresponding to a first user; generating a first embedding by processing the first identifying signal using the UV machine learning model; generating a score based on the first embedding and a first stored embedding; and generating an output based on the score.
Clause 2: A method according to Clause 1, wherein the at least one other computing device is an untrusted device, with respect to the first computing device.
Clause 3: A method according to Clause 1 or 2, wherein: the UV machine learning model was trained at least in part using a federated learning operation performed by a trusted computing device of the first user, the at least one other computing device, and a central server, the federated learning operation was performed based on at least one identifying signal corresponding to the first user, and the at least one identifying signal is unavailable at the central server.
Clause 4: A method according to any of Clauses 1-3, wherein the federated learning operation comprises: generating a training embedding by processing a training identifying signal corresponding to the first user using a version of the UV machine learning model; generating a target embedding by aggregating a user-specific tensor and a weight tensor, wherein the weight tensor is learned during the federated learning operation; and generating a loss based on the training embedding and the target embedding.
Clause 5: A method according to any of Clauses 1-4, wherein the UV machine learning model is further distributed to a plurality of computing devices to perform user verification for a plurality of users.
Clause 6: A method according to any of Clauses 1-5, further comprising receiving the first stored embedding from a trusted computing device of the first user via a trusted communication link.
Clause 7: A method according to any of Clauses 1-6, further comprising: receiving an encrypted first embedding from a secure network location, wherein the encrypted first embedding was transmitted to the secure network location by a trusted computing device of the first user, and decrypting the encrypted first embedding.
Clause 8: A method according to any of Clauses 1-7, further comprising: receiving an updated UV machine learning model, trained using a federated learning operation performed in part by a trusted computing device of a second user; receiving a second identifying signal corresponding to the second user; generating a second embedding by processing the second identifying signal using the updated UV machine learning model.
Clause 9: A method according to any of Clauses 1-8, wherein the first stored embedding was generated, by a trusted device of the first user, by aggregating a user-specific tensor and a weight tensor, wherein the weight tensor was learned during training of the UV machine learning model.
Clause 10: A method according to any of Clauses 1-9, wherein generating the score comprises: computing a distance between the first embedding and the first stored embedding; and determining whether the distance satisfies a defined distance threshold.
Clause 11: A method according to any of Clauses 1-10, wherein generating the output based on the score comprises, in response to determining that the score satisfies one or more defined criteria, granting the first user access to a secured entity.
Clause 12: A method according to any of Clauses 1-11, wherein the secured entity is the first computing device.
Clause 13: A method according to any of Clauses 1-11, wherein the secured entity is a physical space.
Clause 14: A method according to any of Clauses 1-13, wherein the first stored embedding is stored on the first computing device.
Clause 15: A method according to any of Clauses 1-14, wherein the first identifying signal comprises biometric data of the first user.
Clause 16: A method comprising: receiving, at a central server, a plurality of updates from a plurality of untrusted computing devices using a federated learning operation, the plurality of updates generated based on identifying data for a plurality of users; generating, by the central server, a user verification (UV) machine learning model based on the plurality of updates; and deploying the UV machine learning model to an access-controlled computing device, wherein: the access-controlled computing device did not participate in the federated learning operation and is not controlled by any of the plurality of users, and the access-controlled computing device uses the UV machine learning model to verify identities of at least one of the plurality of users.
Clause 17: A method according to Clause 16, further comprising deploying the UV machine learning model to a plurality of access-controlled computing devices.
Clause 18: A method according to Clause 16 or 17, wherein the identifying data for the plurality of users is unavailable on the central server.
Clause 19: A processing system comprising: a memory comprising computer-executable instructions; and one or more processors configured to execute the computer-executable instructions and cause the processing system to perform a method in accordance with any of Clauses 1-18.
Clause 20: A processing system comprising means for performing a method in accordance with any of Clauses 1-18.
Clause 21: A non-transitory computer-readable medium comprising computer-executable instructions that, when executed by one or more processors of a processing system, cause the processing system to perform a method in accordance with any of Clauses 1-18.
Clause 22: A computer program product embodied on a computer-readable storage medium comprising code for performing a method in accordance with any of Clauses 1-18.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
accessing, by a first computing device, a user verification (UV) machine learning model trained on at least one other computing device;
receiving a first identifying signal corresponding to a first user;
generating a first embedding by processing the first identifying signal using the UV machine learning model;
generating a score based on the first embedding and a first stored embedding; and
generating an output based on the score.

2. The computer-implemented method of claim 1, wherein the at least one other computing device is an untrusted device, with respect to the first computing device.

3. The computer-implemented method of claim 2, wherein:
the UV machine learning model was trained at least in part using a federated learning operation performed by a trusted computing device of the first user, the at least one other computing device, and a central server,
the federated learning operation was performed based on at least one identifying signal corresponding to the first user, and
the at least one identifying signal is unavailable at the central server.

4. The computer-implemented method of claim 3, wherein the federated learning operation comprises:
generating a training embedding by processing a training identifying signal corresponding to the first user using a version of the UV machine learning model;
generating a target embedding by aggregating a user-specific tensor and a weight tensor, wherein the weight tensor is learned during the federated learning operation; and
generating a loss based on the training embedding and the target embedding.

5. The computer-implemented method of claim 1, wherein the UV machine learning model is further distributed to a plurality of computing devices to perform user verification for a plurality of users.

6. The computer-implemented method of claim 1, further comprising receiving the first stored embedding from a trusted computing device of the first user via a trusted communication link.

7. The computer-implemented method of claim 1, further comprising:
receiving an encrypted first embedding from a secure network location, wherein the encrypted first embedding was transmitted to the secure network location by a trusted computing device of the first user, and decrypting the encrypted first embedding.

8. The computer-implemented method of claim 1, further comprising:
receiving an updated UV machine learning model, trained using a federated learning operation performed in part by a trusted computing device of a second user;
receiving a second identifying signal corresponding to the second user; and
generating a second embedding by processing the second identifying signal using the updated UV machine learning model.

9. The computer-implemented method of claim 1, wherein the first stored embedding was generated, by a trusted device of the first user, by aggregating a user-specific tensor and a weight tensor, wherein the weight tensor was learned during training of the UV machine learning model.

10. The computer-implemented method of claim 1, wherein generating the score comprises:
computing a distance between the first embedding and the first stored embedding; and
determining whether the distance satisfies a defined distance threshold.

11. The computer-implemented method of claim 1, wherein generating the output based on the score comprises, in response to determining that the score satisfies one or more defined criteria, granting the first user access to a secured entity.

12. The computer-implemented method of claim 11, wherein the secured entity is the first computing device or a physical space.

13. The computer-implemented method of claim 1, wherein the first stored embedding is stored on the first computing device.

14. The computer-implemented method of claim 1, wherein the first identifying signal comprises biometric data of the first user.

15. A computer-implemented method comprising:
receiving, at a central server, a plurality of updates from a plurality of untrusted computing devices using a federated learning operation, the plurality of updates generated based on identifying data for a plurality of users;
generating, by the central server, a user verification (UV) machine learning model based on the plurality of updates; and
deploying the UV machine learning model to an access-controlled computing device, wherein:
the access-controlled computing device did not participate in the federated learning operation and is not controlled by any of the plurality of users, and
the access-controlled computing device uses the UV machine learning model to verify identities of at least one of the plurality of users.

16. The computer-implemented method of claim 15, further comprising deploying the UV machine learning model to a plurality of access-controlled computing devices.

17. The computer-implemented method of claim 15, wherein the identifying data for the plurality of users is unavailable on the central server.

18. A processing system, comprising:
a memory comprising computer-executable instructions; and
one or more processors configured to execute the computer-executable instructions and cause the processing system to perform an operation comprising:
accessing, by a first computing device, a user verification (UV) machine learning model trained on at least one other computing device;
receiving a first identifying signal corresponding to a first user;
generating a first embedding by processing the first identifying signal using the UV machine learning model;
generating a score based on the first embedding and a first stored embedding; and
generating an output based on the score.

19. The processing system of claim 18, wherein the at least one other computing device is an untrusted device, with respect to the first computing device.

20. The processing system of claim 19, wherein:
the UV machine learning model was trained at least in part using a federated learning operation performed by a trusted computing device of the first user, the at least one other computing device, and a central server,
the federated learning operation was performed based on at least one identifying signal corresponding to the first user, and
the at least one identifying signal is unavailable at the central server.

21. The processing system of claim 20, wherein the federated learning operation comprises:
generating a training embedding by processing a training identifying signal corresponding to the first user using a version of the UV machine learning model;
generating a target embedding by aggregating a user-specific tensor and a weight tensor, wherein the weight tensor is learned during the federated learning operation; and
generating a loss based on the training embedding and the target embedding.

22. The processing system of claim 18, wherein the UV machine learning model is further distributed to a plurality of computing devices to perform user verification for a plurality of users.

23. The processing system of claim 18, the operation further comprising receiving the first stored embedding from a trusted computing device of the first user via a trusted communication link.

24. The processing system of claim 18, the operation further comprising:
receiving an encrypted first embedding from a secure network location, wherein the encrypted first embedding was transmitted to the secure network location by a trusted computing device of the first user, and
decrypting the encrypted first embedding.

25. The processing system of claim 18, the operation further comprising:
receiving an updated UV machine learning model, trained using a federated learning operation performed in part by a trusted computing device of a second user;
receiving a second identifying signal corresponding to the second user; and
generating a second embedding by processing the second identifying signal using the updated UV machine learning model.

26. The processing system of claim 18, wherein the first stored embedding was generated, by a trusted device of the first user, by aggregating a user-specific tensor and a weight tensor, wherein the weight tensor was learned during training of the UV machine learning model.

27. The processing system of claim 18, wherein generating the score comprises:
computing a distance between the first embedding and the first stored embedding; and
determining whether the distance satisfies a defined distance threshold.

28. The processing system of claim 18, wherein generating the output based on the score comprises, in response to determining that the score satisfies one or more defined criteria, granting the first user access to a secured entity.

29. The processing system of claim 28, wherein the secured entity is the first computing device or a physical space.

30. The processing system of claim 18, wherein the first stored embedding is stored on the first computing device.

31. The processing system of claim 18, wherein the first identifying signal comprises biometric data of the first user.

32. A processing system, comprising:
a memory comprising computer-executable instructions; and
one or more processors configured to execute the computer-executable instructions and cause the processing system to perform an operation comprising:
receiving, at a central server, a plurality of updates from a plurality of untrusted computing devices using a federated learning operation, the plurality of updates generated based on identifying data for a plurality of users;
generating, by the central server, a user verification (UV) machine learning model based on the plurality of updates; and
deploying the UV machine learning model to an access-controlled computing device, wherein:
the access-controlled computing device did not participate in the federated learning operation and is not controlled by any of the plurality of users, and
the access-controlled computing device uses the UV machine learning model to verify identities of at least one of the plurality of users.

33. The processing system of claim 32, the operation further comprising deploying the UV machine learning model to a plurality of access-controlled computing devices.

34. The processing system of claim 32, wherein the identifying data for the plurality of users is unavailable on the central server.

35. A non-transitory computer-readable medium comprising computer-executable instructions that, when executed by one or more processors of a processing system, cause the processing system to perform an operation comprising:
accessing, by a first computing device, a user verification (UV) machine learning model trained on at least one other computing device;
receiving a first identifying signal corresponding to a first user;
generating a first embedding by processing the first identifying signal using the UV machine learning model;
generating a score based on the first embedding and a first stored embedding; and
generating an output based on the score.
